(19) United States
(12) Patent Application Publication
(10) Pub. No.: US 2023/0367036 A1
(43) Pub. Date: Nov. 16, 2023

(54) METASTRUCTURE OPTICAL ELEMENTS, METASTRUCTURE OPTICAL ASSEMBLIES, AND METHODS OF MANUFACTURING THE SAME

(71) Applicant: NILT SWITZERLAND GmbH, Horgen (CH)

(72) Inventor: Maksim ZALKOVSKIJ, Kongens Lyngby (DK)

(21) Appl. No.: 18/245,579

(22) PCT Filed: Sep. 15, 2021
(86) PCT No.: PCT/EP2021/075385

§ 371 Date: Mar. 16, 2023

Related U.S. Application Data
(60) Provisional application No. 63/080,212, filed on Sep. 18, 2020.

(51) Int. Cl. G02B 1/00

(52) U.S. Cl. CPC G02B 1/002

(57) ABSTRACT

The present disclosure describes metastructure optical elements, assemblies, and methods of their manufacture. In some implementations, a metastructure optical element includes a first grouping of meta-atoms having a first etch characteristic. The first grouping of meta-atoms is composed of a first etched stratum. The metastructure optical element further includes a second grouping of meta-atoms having a second etch characteristic. The second grouping of meta-atoms is composed of a second etched stratum and an etched optical etch-deceleration layer. The second etched stratum is disposed on the etched optical etch-deceleration layer, and the etch-deceleration layer is disposed on a substrate.

### FIELD OF THE DISCLOSURE

The present disclosure relates to metastructure optical elements and methods of their manufacture.

### BACKGROUND

Metastructure optical elements include a plurality of meta-atoms. The manufacture of metastructure optical elements typically involves etching the meta-atoms into a stratum, such as polysilicon. The meta-atoms may occur in different groupings within the metastructure optical element. The different groupings of meta-atoms may have different etch characteristics. For example, the density of the meta-atoms in one grouping may be less than in another grouping. Consequently, metastructure optical elements configured with two or more groupings having different etch characteristics may be particularly difficult or even impossible to manufacture using typical etching methods.

### SUMMARY

The present disclosure describes metastructure optical elements. In some implementations a metastructure optical element includes a first grouping of meta-atoms having a first etch characteristic. The first grouping of meta-atoms is composed of a first etched stratum. The metastructure optical element further includes a second grouping of meta-atoms having a second etch characteristic. The second grouping of meta-atoms is composed of a second etched stratum and an etched optical etch-deceleration layer. The second etched stratum is disposed on the etched optical etch-deceleration layer, and the etch-deceleration layer is disposed on a substrate.

The aforementioned metastructure optical element can, in some instances, exhibit more advanced or sophisticated optical functionality due to the incorporation of two or more groupings of meta-atoms with different etch characteristics into the optical design of the metastructure optical element.

In some implementations, the metastructure optical element includes the first grouping of meta-atoms being disposed with a higher density than the second grouping of meta-atoms. This aspect can permit the incorporation of advanced optical functionality into the optical design of the metastructure optical element.

The present disclosure further describes metastructure optical element assemblies. In some implementations, a metastructure optical element assembly includes a substrate and an etch-deceleration layer disposed on the substrate. The metastructure optical element assembly further includes a stratum disposed on the etch-deceleration layer, and a mask disposed on the stratum. Such an assembly may be supplied as an intermediate product to a sub-manufacturer, for example, with etching capabilities suitable for etching the metastructure optical element assembly and discretizing the assembly into discrete metastructure optical elements.

In some implementations, the metastructure optical element assembly further includes an adhesion layer disposed between the substrate and the etch-deceleration layer. The adhesion layer may prevent delamination of the optical etch-deceleration layer from the substrate.

The present disclosure further describes processes for manufacturing one or more metastructure optical elements. In some implementations a method for manufacturing one or more metastructure optical elements includes:
a. determining a configuration of meta-atoms to satisfy an optical performance specification;
b. identifying groupings of meta-atoms with different etch characteristics;
c. associating a respective etch rate with each of the identified groupings;
d. associating an etched amount of an optical etch-deceleration layer with each of the different groupings of meta-atoms;
e. reconfiguring the configuration of meta-atoms to meet the optical performance specification;
f. forming a mask on a stratum;
g. etching the groupings of meta-atoms into the stratum and into the etch-deceleration layer, the amount according to each grouping; and
h. removing the mask.

The aforementioned process for manufacturing a metastructure optical element can permit more advanced or sophisticate optical functionality due to the incorporation of two or more groupings of meta-atoms with different etch characteristics into the optical design of the metastructure optical element and can permit the metastructure optical element to be manufactured.

The present disclosure further describes optoelectronic modules. In some implementations, an optoelectronic module includes a housing and an active optoelectronic element configured to emit or receive light disposed in the housing. The optoelectronic module further includes a metastructure optical element integrated into the housing and functionally disposed relative to the active optoelectronic element. The metastructure optical element being manufactured according to the processes described in the present disclosure. Such optoelectronic modules can exhibit advanced or more sophisticated optical functionality due to the metastructure optical element having two or more groupings of meta-atoms with different etch characteristics incorporated therein.

Other aspects, features and advantages will be readily apparent form the following detailed description, the accompanying drawings, and the claims.

### BRIEF DESCRIPTION OF THE DRAWINGS

FIG. 1A-FIG. 1D depict example process steps for manufacturing one or more metastructure optical elements.

FIG. 2A-FIG. 2C depict example process steps for manufacturing one or more metastructure optical elements.

FIG. 2D-FIG. 2E depict examples of metastructure optical assemblies.

FIG. 3 illustrates an example process for manufacturing one or more metastructure optical elements.

FIG. 4A-FIG. 4B depict an example metastructure optical element.

FIG. 5 depicts an example optoelectronic module in which a metastructure optical element is integrated.

### DETAILED DESCRIPTION

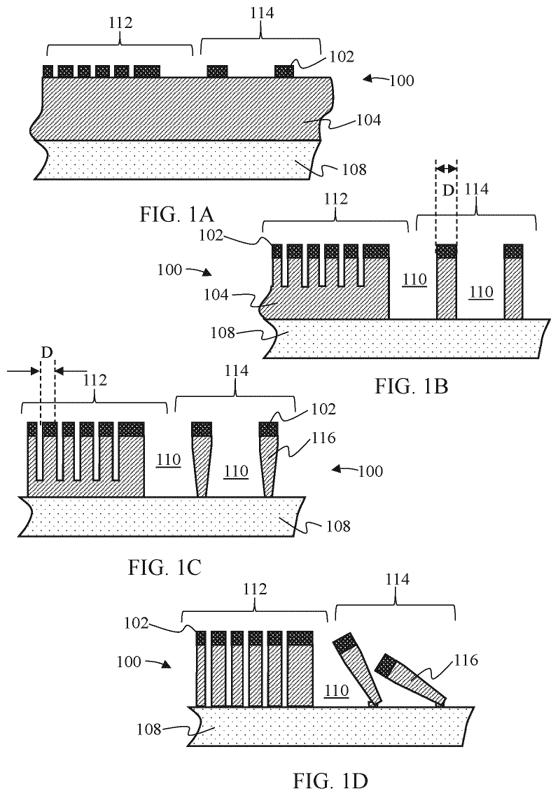

FIG. 1A-FIG. 1D depict examples of several stages of the manufacturing process of one or more metastructure optical elements. A metastructure optical assembly, as in the metastructure optical assembly 100 depicted in FIG. 1A-FIG. 1D, is an intermediary product created during the manufacture of one or more metastructure optical elements. The metastructure optical assembly 100 includes a mask 102, such as an organic (e.g., amorphous carbon) or inorganic (e.g., SiN, SiON, TiN) hardmask disposed on a stratum 104 (e.g., polysilicon). In some instances, the hardmask may be composed of metal, such as chrome. The mask 102 may be deposited on the stratum 104 by sputtering or chemical vapor deposition, for example. The stratum 104 is disposed on a substrate 108 (e.g., glass, fused silica). The stratum 104 may be deposited onto the substrate 108 by chemical vapor deposition, for example. The metastructure optical assembly 100 can take the form of a wafer having a large lateral dimension with many metastructure optical elements. For example, some wafers may have a radius from 1 inch to more than 20 inches and a thickness of only a few hundred microns, though wafers having other dimensions are within the scope of this disclosure.

The stratum 104 can be etched, for example, by reactive ion etching as indicated by etched material 110 in FIG. 1B-FIG. 1D. The amount of etched material 110 can be different for different areas of the metastructure optical assembly 100. For example, a first grouping of meta-atoms having a first etch characteristic 112 and a second grouping of meta-atoms having a second etch characteristic 114 are depicted. Different etch characteristics between the groupings may be exhibited due to different densities of individual meta-atoms 116, for example. That is, in some cases, the sum of the areas (e.g., determined via the meta-atom diameters D) of the individual meta-atoms 116 within a particular grouping 112 divided by the area of the metastructure optical element over which that particular grouping occupies may be different than the same for another grouping 114 of meta-atoms 116.

Metastructure optical elements include a multiplicity of meta-atoms 116. The meta-atoms 116 operate together such that the metastructure optical element exhibits some optical effect. A metastructure optical assembly 100 can include just a few metastructure optical elements, tens, hundreds, even thousands of metastructure optical elements in some cases. Each metastructure optical element can include just a few meta-atoms, to tens, hundreds, thousands, even tens-of thousands of meta-atoms. Each of the metastructure optical elements may include two or more groupings of meta-atoms having different etch characteristics. In some instances, as depicted in FIG. 1D, some of the meta-atoms 116 within at least one of the groupings may fail, fracture, or otherwise be destroyed during the etching process since the etch rate is different between the two groupings 112 and 114.

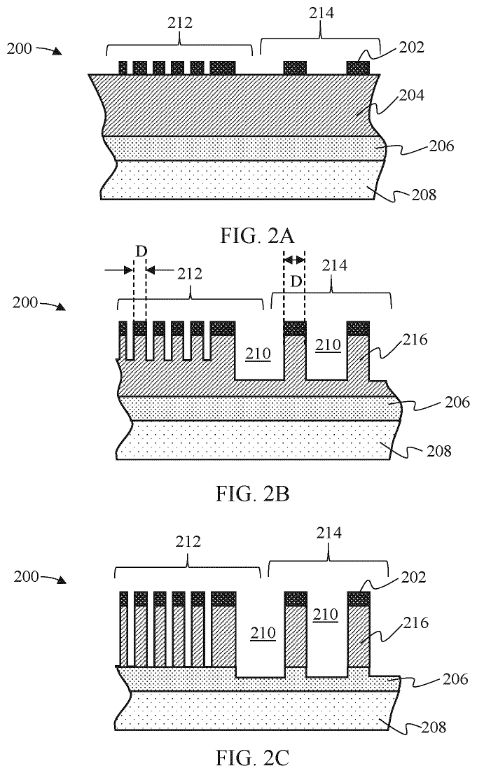

FIG. 2 depicts example process steps for manufacturing one or more metastructure optical elements. The depicted process steps are similar to those described above and depicted in FIG. 1A-FIG. 1D. A metastructure optical assembly 200 includes a mask 202, such as an organic (e.g., amorphous carbon) or inorganic (e.g., SiN, SiON, TiN) hardmask disposed on a stratum 204 (e.g., polysilicon). In some instances, the hardmask may be composed of metal, such as chrome. The mask 202 may be deposited on the stratum 204 by sputtering or chemical vapor deposition, for example. The stratum 204 is disposed on an optical etch-deceleration layer 206. The maximum allowable thickness of the optical etch-deceleration layer 206 is dependent on its optical properties such as its refractive index and the operating wavelength of the metastructure optical element. In general, the maximum allowable thickness of the optical etch-deceleration layer 206 should be some fraction of the shortest operating wavelength. In some instances, the minimum thickness of the optical etch-deceleration layer 206 is a few nanometers, though in other instances, the minimum thickness may be a few hundred nanometers or more.

The stratum 204 may be deposited on the optical etch-deceleration layer 206 by chemical vapor deposition, for example. The optical etch-deceleration layer 206 is disposed on a substrate 208 (e.g., glass, fused silica). The optical etch-deceleration layer 206 may be deposited onto the substrate 208 by chemical vapor deposition, for example. The metastructure optical assembly 200 can take the form of a wafer having a large lateral dimension with many metastructure optical elements. For example, some wafers may have a radius from 1 inch to more than 20 inches and a thickness of only a few hundred microns, though wafers having other dimensions are within the scope of this disclosure.

The stratum 204 can be etched, for example, by reactive ion etching as indicated by etched material 210 in FIG. 2B-FIG. 2C. The amount of etched material 210 can be different for different areas of the metastructure optical assembly 200. For example, a first grouping of meta-atoms having a first etch characteristic 212 and a second grouping of meta-atoms having a second etch characteristic 214 are depicted. Different etch characteristics between the groupings may be exhibited due to different densities of individual meta-atoms 216, for example. That is, in some cases, the sum of the areas (e.g., determined via the meta-atom diameters D) of the individual meta-atoms 216 within a particular grouping 212 divided by the area of the metastructure optical element over which that particular grouping occupies may be different than the same for another grouping 214 of meta-atoms 216.

Metastructure optical elements include a multiplicity of meta-atoms 216. The meta-atoms 216 operate together such that the metastructure optical element exhibits some optical effect. A metastructure optical assembly 200 can include just a few metastructure optical elements, tens, hundreds, even thousands of metastructure optical elements in some cases. Each metastructure optical element can include just a few meta-atoms 216, to tens, hundreds, thousands, even tens-of thousands of meta-atoms 216. Each of the metastructure optical elements may include two or more groupings (such as 212 and 214) of meta-atoms 216 having different etch characteristics.

The optical etch-deceleration layer 206 may be configured to deflect further etching of the stratum 204 from which the individual meta-atoms 216 are composed. For example, the first grouping of meta-atoms 212 with the first etch characteristic exhibits a slower etch characteristic compared to the second grouping of meta-atoms 214 with the second etch characteristic. Consequently, the optical etch-deceleration layer 206 deflects further etching of the stratum 204 that makes up the individual meta-atoms 216 within the grouping 214. In some instances, the etch-deceleration layer 206 is etched instead (as depicted). In some instances, the etch-deceleration layer 206 may inhibit etching of the stratum 204 in the immediate vicinity of the individual meta-atoms 216 within the grouping 214 by absorbing power, for example.

FIG. 2D depicts an example metastructure optical assembly 200D. The metastructure optical assembly 200D includes an adhesion layer 215 between the stratum 204 and the optical etch-deceleration layer 206. The adhesion layer 215 is configured to prevent delamination of the stratum 204 from the optical etch-deceleration layer 206. For example, in instances where the optical etch-deceleration layer 206 is composed of Al₂O₃ and the stratum 204 is composed of polysilicon an adhesion layer composed of SiO₂ may be disposed therebetween. The adhesion layer 215 may be located between other components of the metastructure optical assembly. For example, as depicted in FIG. 2E, an example metastructure optical assembly 200E includes an adhesion layer 215 between the optical etch-deceleration layer 206 and the substrate 208. Still in other embodiments, the adhesion layer 215 may be located both between the substrate 208 and the optical etch-deceleration layer 206 and between the stratum 204 and the optical etch-deceleration layer 206. The maximum allowable thickness of the adhesion layer 215 in any of the described implementations is dependent on its optical properties such as its refractive index and the operating wavelength of the metastructure optical element.

In general, the maximum allowable thickness of the adhesion layer 215 should be some fraction of the shortest operating wavelength (i.e., the wavelength for which the metastructure optical element is designed). The minimum allowable thickness of the adhesion layer 215 is dependent on the mechanical interface between the adhesion layer 215 and the components between which it is disposed. For example, the optical etch-deceleration layer 206 and the adhesion layer 215 and the substrate 208. The adhesion layer 215 should be thick enough to prevent its delamination from either the optical etch-deceleration layer 206 and/or the substrate 208. In some embodiments, not depicted, the adhesion layer 215 and the optical etch-deceleration layer 206 may be one and the same. That is, the optical etch-deceleration layer 206 may be configured to deflect further etching of the stratum 204 from which the individual meta-atoms 216 are composed, and the optical etch-deceleration layer 206 may be further configured to prevent delamination of the components between which the optical etch-deceleration layer 206 is disposed.

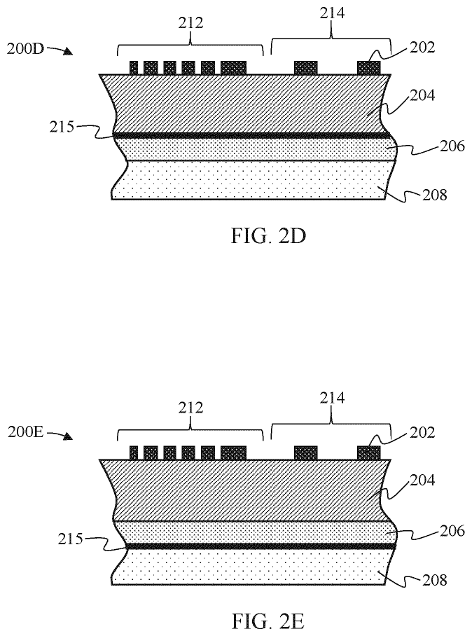

FIG. 3 illustrates an example process 300 for manufacturing one or more metastructure optical elements. As indicated by 302, a configuration of meta-atoms to satisfy an optical performance specification is determined. As indicated by 304, groupings of meta-atoms with different etch characteristics are identified. As indicated by 306, etch rates are associated with each of the identified groupings. As indicated by 308, an etched amount of an optical etch-deceleration layer is associated with each of the different groupings of meta-atoms. As indicated by 310, the configuration of meta-atoms is reconfigured to meet the optical performance specification in the event the etched amount of the optical etch-deceleration layer exceeds some maximum. As indicated by 312, a hardmask is formed on a stratum. As indicated by 314, the groupings of meta-atoms are etched into the stratum and into the etch-deceleration layer, the amount according to each grouping. As indicated by, the mask is removed to form the one or more metastructure optical elements.

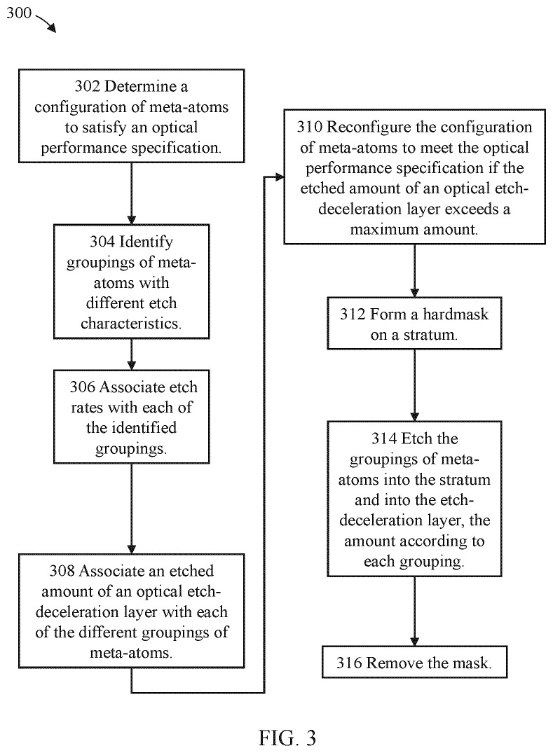

4A-FIG. 4B depict an example metastructure optical element 400. The side view incudes the components as depicted in FIG. 2A-FIG. 2C and described above, however, the mask 202 has been removed. The first and second groupings (212 and 214) of meta-atoms with different etch characteristics is depicted. Different etch characteristics between the groupings may be determined by the different densities of individual meta-atoms 216 in this example. That is, in some cases, the sum of the areas (e.g., determined via the meta-atom diameters D) of the individual meta-atoms 216 within a particular grouping 212 divided by the area of the metastructure optical element over which that particular grouping occupies (the rectangular dashed lines depicted in FIG. 4B) may be different than the same for another grouping 214 of meta-atoms 216.

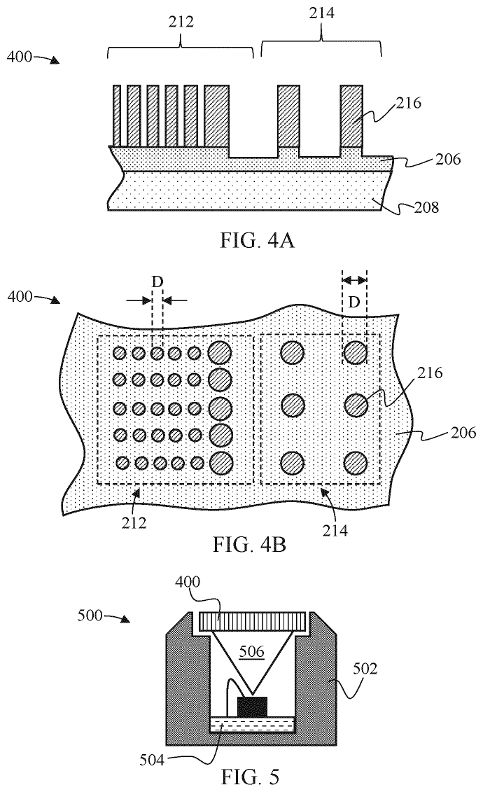

FIG. 5 depicts an example optoelectronic module 500 in which a metastructure optical element 400 manufactured according to the disclosed process is integrated. The optoelectronic module 500 includes a housing 502. The housing 502 can be composed of polymeric material, and may be manufactured by injection molding, for example. In some instances, the housing 502 can be composed of a lead frame and be composed of a ceramic and metal material. The optoelectronic module 500 further includes an active optoelectronic element 504 configured to emit or receive light 506. The metastructure optical element 400 is functionally disposed relative to the active optoelectronic element 504. That is, the metastructure optical element 400 is disposed such that the metastructure optical element 400 and the active optoelectronic element 504 can generate the intended optical effect during normal operation of the optoelectronic module 500. Optoelectronic modules such as the example depicted in FIG. 5 and described above can exhibit advanced or more sophisticated optical functionality due to the metastructure optical element having two or more groupings of meta-atoms with different etch characteristics incorporated therein.

Various modifications may be made within the spirit of this disclosure. Accordingly, other implementations also are within the scope of the claims.

1. An apparatus comprising a metastructure optical element comprising:
a first grouping of meta-atoms having a first etch characteristic, the first grouping of meta-atoms being composed of a first etched stratum; and
a second grouping of meta-atoms having a second etch characteristic, the second grouping of meta-atoms being composed of a second etched stratum and an etched optical etch-deceleration layer;
the second etched stratum being disposed on the etched optical etch-deceleration layer, and the etch-deceleration layer being disposed on a substrate.

2. The apparatus of claim 1, the metastructure optical element further comprising an adhesion layer disposed between the second stratum and the optical etch-deceleration layer.

3. The apparatus of claim 1, the metastructure optical element further comprising an adhesion layer disposed between the optical etch-deceleration layer and the substrate.

4. The apparatus of claim 1, wherein the first grouping of meta-atoms is of a higher density than the second grouping of meta-atoms.

5. An apparatus comprising a metastructure optical element assembly comprising:
a substrate, an etch-deceleration layer disposed on the substrate;
a stratum disposed on the etch-deceleration layer; and
a mask disposed on the stratum.

6. The apparatus of claim 5, the metastructure optical element assembly further comprising an adhesion layer disposed between the substrate and the etch-deceleration layer.

7. The apparatus of claim 5, the metastructure optical element assembly further comprising an adhesion layer disposed between the stratum and the etch-deceleration layer.

8. A method for manufacturing a metastructure optical element, the method comprising:
determining a configuration of meta-atoms to satisfy an optical performance specification;
identifying groupings of meta-atoms with different etch characteristics;
associating a respective etch rate with each of the identified groupings;
associating an etched amount of an optical etch-deceleration layer with each of the different groupings of meta-atoms;
reconfiguring the configuration of meta-atoms to meet the optical performance specification;
forming a mask on a stratum;
etching the groupings of meta-atoms into the stratum and into the etch-deceleration layer, the amount according to each grouping; and
removing the mask.

9. The apparatus of claim 1 further comprising:
a housing; and
an active optoelectronic element disposed in the housing, the active optoelectronic component configured to emit or receive light;
wherein the metastructure optical element is integrated into the housing and functionally disposed relative to the active optoelectronic element.
